(19) United States
(12) Patent Application Publication
(10) Pub. No.: US 2007/0002313 A1
(43) Pub. Date: Jan. 4, 2007

(54) Process and apparatus for the identification of the tin side and the firing side in float glass

(76) Inventors: Klaus Jürgen Berg, Halle (DE); Dieter Mogalle, Halle (DE); Andreas Muller, Halle (DE); Thomas Rainer, Wernigerode (DE); Steffen Kurbitz, Halle (DE)

Correspondence Address: CHADBOURNE & PARKE LLP, 30 ROCKEFELER PLAZA, NEW YORK, NY, 10112, US

(21) Appl. No.: 11/144,105

(22) Filed: Jun. 3, 2005

(30) Foreign Application Priority Data
Jun. 4, 2004 (DE) 10 2004 027 411.8

(51) Int. Cl. G01N 21/41; G01N 21/00

(52) U.S. Cl. 356/128; 356/433

(57) ABSTRACT

The invention relates to a process and an apparatus for the identification of the tin and firing sides of float glass, in particular during an automated production process, whereby a property of the float glass, in particular an optical property, differentiating the tin side and the firing side is determined by measuring techniques from the direction of one of the two sides or on one of the two sides, and a measured value resulting thereform is compared with a predetermined reference value, whereby the tin side and the firing side of the float glass are determined from the result of the comparison.

### FIELD OF THE INVENTION

The invention concerns a process and the apparatus for the identification of the tin and firing sides of float glass, in particular during an automated manufacturing process.

### BACKGROUND OF THE INVENTION

During the production process, float glass or flat glass is poured as molten glass onto a tin bath, so that—conditioned by the manufacturing process—the float glass features on its two surfaces a different chemical composition, whereby in particular the tin ion content on the surface which was during fabrication in contact with the tin bath (the tin side) is substantially greater than on the so-called firing or atmospheric side.

These float glass differences cannot be visually observed by the human eye, but they do lead to different properties and different float glass behavior in many processing and finishing processes.

For example, the formation of cracks and the wettability as well as the behavior in the application of coatings and in ion exchange and also in the final on-site cleansing of single-plate safety glass differ, depending on whether they are examined on the tin side or the firing side of float glass.

Accordingly, based on the differential properties of the firing or tin-side of float glass, it is necessary to identify and differentiate the particular sides from each other, in order to achieve optimal quality ensurance in particular in automated production processes by which float glass is fabricated and/or further machined.

At this time, in the state of the art there are essentially two methods available to differentiate the two sides. One method involves a hydrochemical assay, whereby under a drop of hydrofluoric acid in which silver nitrate has been dissolved, a black coloration develops on the tin side, which can be visually detected with the naked eye by the observer. The other method involves exposing the glass sides to ultraviolet light, whereby an observer may visually detect with the naked eye a phenomenon of fluorescence on the tin side.

The shortcoming of both these procedures lies in the fact that the methods essentially require manual application and that the outcome depends on the subjective perception of the observer. Beyond that, the hydrochemical method must be regarded as complicated and costly in materials.

The task of the invention is to make available a process and apparatus by means of which to secure an objective test for the identification and differentiation of the tin and firing sides of float glass, whereby both the procedure and the apparatus may be incorporated in an automated production process for the fabrication and/or processing of float glass.

According to the invention, the task is resolved in that the process detects by a measuring technique a tin and firing side-differentiating, in particular optical, property of the float glass from the direction of one of the two sides, or on one of the two sides, and the resulting measured value is compared with a predetermined reference value, whereby from the result of the comparison the tin and firing sides of the float glass are determined.

Within the meaning of the invention, a tin and firing side-differentiating property is understood to mean that one side may display a property not displayed on the other side, or that a property is more outspoken at or on one side than at or on the other.

Within the meaning of the invention, detection by a measuring technique is understood to mean that a measured magnitude or measured value so detected is representative of the thickness, magnitude or extent of a property. Hence, the measured magnitude or value of such property will depend on whether the measured magnitude or value was detected by the measuring technique from the direction and/or on one or the other side.

Accordingly, such a process may be carried out by means of an apparatus comprising according to the invention a measuring device by means of which a tin or firing-side differentiating, especially optical, property of the float glass may be detected from the direction or upon one of the two sides and in which the measured value resulting from such measurement may be compared against a predetermined reference value, so as to reach a conclusion from such comparison as to the tin or firing side of the float glass.

Compared to the heretofore available methods, the measuring technique detection, in particular with the measuring device contemplated herein, features the advantage that the outcome is the result of an objective measuring technique or mechanical comparison, ruling out erroneous assessments by the subjective observation of an individual heretofore using the known methods.

Beyond that, by means of a measuring-technique detection of a property, particularly an optical property, of the float glass, the measurement may be fed to an automated production process, allowing continuous verification of the correct orientation of the float glass during the manufacturing, fabricating, production and processing operations.

In comparing the value of a measured property, particularly an optical property of the float glass against a reference value, it is in the last analysis dependent on the kind of measured property what result the comparison will yield. For example, in a comparison against a reference value wherein the measured value falls below the reference value, a conclusion may be reached as to whether the measurement was performed from the direction or on the tin side or the firing side of the glass, so as to thereby permit unquestionable determination of the location of the tin or firing side of the float glass, for example to secure correct orientation in an automated production process of float glass. Of course, provision may also be made for the comparison to come out with the opposite result, as for example in checking out a different, notably optical, property.

Basically, the reference value may be predetermined to represent a static invariable value. Nevertheless, since it may occur that the optical properties of the glass may vary depending on the production batch from which the glass came, a comparison with a static reference value may lead to imprecise or erroneous results, so that a further preferred embodiment may provide for the reference value to be determined by the measuring-technique assessment of the same, particularly optical, property from the direction or on the other side of the float glass.

Accordingly, to identify the tin and firing sides in the preferred process, one and the same measurement of a property, notably an optical property, is performed both at/on one side as well as at/on the other side of float glass, whereby the result of the measurement at/on one side forms the measured value and the result of the measurement at/on the other side the reference value within the meaning of the process according to the invention.

For the performance of the process in a device, provision may accordingly be made for the device to feature a measuring device performing one after the other measurements at/on the one side, and then at/on the other side, or else for the device to feature two independent measuring devices, by means of which it is possible to determine simultaneously the measured value and the reference value within the meaning of the invention.

Basically, within the framework of the invented process and/or the device according to the invention, it is possible to measure any and all properties of the float glass, whose measured magnitude/measured value depends on whether they were measured on the tin or the firing side and are available for comparative observations and, by the same token, for identification purposes. Preferred for the measurement are optical properties in that for the measurement of such properties it is customarily possible to rely on simple apparatus and detectors.

Accordingly, depending on the properties, notably optical properties, to be measured, measuring devices are chosen for the devices used in the execution of the process whereby these may for example consist of radiation sources and radiation detectors, suitable for example for the generation and measurement of light intensity.

In a preferred embodiment of the process or the device, provision may be made for the measured value and/or the reference value of an optical property to be dependent on the intensity of the fluorescent light generated on a float glass surface by reason of an irradiated UV light.

### SUMMARY OF THE INVENTION

This procedure according to the invention is predicated on the property of float glass that, compared to the firing side, the tin side displays an enhanced tendency to fluorescence upon radiation particularly of ultraviolet light. Accordingly, the intensity of the fluorescent light generated by the irradiation, for example, of UV light, will be greater than on the firing side, hence the possibility to determine a measured value and a reference value dependent throughout on the intensity of the generated fluorescent light, whereby the measured value may directly represent the intensity of the fluorescent light or represent a value computed from the measured intensity.

Basically, there is a possibility to measure the intensity of the fluorescent light from that side from which the UV light generating the fluorescence phenomenon on the float glass plate is irradiated.

In a specially preferred embodiment, however, an arrangement is chosen wherein the measured value and/or the reference value depend on the intensity of the fluorescent light generated on one side of the float glass, traveling through the glass and being received behind the other side.

Accordingly, in a measured-technique arrangement, UV light, for example, is irradiated onto the float glass from a chosen side, thereby triggering a fluorescent light phenomenon near the surface. Because of the thickness of the float glass, the irradiated UV light is absorbed into the glass to such an extent as to preclude substantially any significant transmission of the irradiated UV light to the opposite side. This may preferentially be accomplished by choosing a light wavelength on the short-wave side of the U.V. absorption limit of the chosen type of glass.

Conversely, the fluorescent light typically generated in the longer wavelength region, in terms of the UV absorption limit, may penetrate the float glass without any further significant absorption, so that in making measurements from the side opposite the irradiation side, merely the fluorescent light but not the irradiated UV light may be detected. Accordingly, in this procedure, the value measured by the measuring technique may be displayed adjusted for the background.

The measured value so obtained is compared to the reference value obtained in one and the same manner, but from the opposite side of the float glass. In comparing the measured value with the reference value, it will be noted that in securing the measured value from the tin side of the float glass, the intensity of the measured fluorescent light was appreciably higher than in collecting the reference value from the firing side. Accordingly, the comparison unequivocally shows which side of the tested float glass is the tin side or the firing side.

In order to perform such a measurement, a spectrophotometer should preferably be used. Spectrophotometers, basically known to the expert, are used to measure optical density of materials. To this end, the spectrophotometer irradiates samples of test material with a monochromatic beam and the intensity of the transmitted beam is measured with a wide-band receiver, as for example a photomultiplier.

Because of the fact, as previously described, that depending on the measuring direction, that is, depending on the side of the float glass being examined, more or less intensive phenomena of fluorescence appear when the glass is irradiated with a UV source of light; accordingly, the optical density of the float glass measured in the wave-length range wherein fluorescence is triggered (the UV range) will vary depending on the measuring direction, since a more intensive fluorescent light is generated when float glass is irradiated in the direction of the tin side, thereby yielding a measurement of optical density which, because of the component of fluorescent light, is significantly adulterated in the direction of lower optical densities.

Accordingly, when optical density of float glass is measured by irradiating the tin side of float glass, the outcome will be an optical density lower than would be secured by the same measurement if the beam were irradiated from the firing side. A comparison of the measured values would therefore permit unequivocal identification of the tin side or the firing side.

However, a precondition for an objectively accurate identification of the particular sides when using a spectrophotometer is that the false irradiation known in spectral photometry to cause a systematic error be smaller than the fluorescent light component from the tin side of float glass. To summarize, it must be accordingly noted that the fluorescent light of a fluorescent glass specimen also acts not unlike the equipment-proper radiation of spectrophotometers. Hence, the more intensive the fluorescent light, the lower the measured optical density displayed by the spectrophotometer in the wavelength range of the triggering irradiation. Accordingly, in the wavelength region of the triggering irradiation, on the shortwave end of the UV absorption limit of the tested glass, the measured optical density will be lower when the tin side faces the source of radiation, compared to the opposite case.

In this connection, as previously mentioned, it is advantageous that by reason of the sharp absorption of the ultraviolet triggering light in glass, the fluorescent light be triggered only on the glass surface directly facing the source of the radiation. Inasmuch as this fluorescence light is capable of penetrating and reaching the broad-band receiver of a spectrophotometer, the glass being virtually free of absorption in the visible range of spectral fluorescence, the fluorescent light component ultimately producing a faulty measurement in relation to the measurement of optical density at the excitation wavelength may be used for the identification of the tin side versus the firing side. The execution of the process with a device featuring such a spectrophotometer is particularly simple and economical, since the corresponding apparatus for the identification and differentiation of the two float glass sides may utilize conventional commercially available spectrophotometers, without any need for further modification.

In another alternative, provision can be made for the measured value and/or the reference value of an optical property to depend on the intensity of a light reflected from an irradiated light, in particular when the light is only reflected on the first surface of the float glass in the direction of the radiation.

Consistent with the invented process, this further alternative is based on the thought that because of its differential chemical properties on the tin side and the firing side, it would also possess different refraction indices, so that by recording measured values deviating on the two sides by reason of the different refraction indices, in would also make it possible to distinguish the tin side from the firing side of float glasses.

Accordingly, a device for the implementation of the process can provide for a light source to illuminate the surface of a float glass by means of a chosen wavelength, to observe the intensity of the reflected light. To this end, a light source should preferentially be chosen whose radiated light features a wavelength on the shortwave UV absorption limit of the measured glass, since in that case, in an especially preferred measuring arrangement the irradiated light will only be reflected on the first surface of the float glass in the direction of irradiation, but because of the strong absorption inside the glass it would not be reflected by the second surface lying on the opposite side, inasmuch as that surface is for all practical purposes no longer reached by the irradiated light.

Accordingly, the preferred arrangements for the performance of the process would be those allowing the least possible transmission of the irradiated light, whereby the preferred transmission would be below 10%, preferably below 4% and most preferably below 1%.

Accordingly, a device for the execution of this alternative process features a measuring device by which to determine a measured value and/or a reference value depending on the intensity of the light reflected from one of the float glass surfaces, whereby a UV source of light would be especially preferred, along with a UV-sensitive detector for the measurement of the reflected light intensity, as for example a photo diode. As a light source, an especially preferred choice would be a UV fluorescent lamp with an emission maximum of approx. 253 nanometers.

The detector for the measurement of the light intensity of the reflected light features preferably a sensitive spectrum range of 230 to 530 nanometer, as offered by silicon-based photodiodes.

If the mentioned invented process is carried out by such a device, a differential reflection behavior of the two sides can be detected on the basis of the differential refractive index of the tin side and the firing side. In the short-wave wavelength range of the absorption limit, where absorption is so strong that the reflected light is only registered by the detector on the forward side, the reflection observed on the tin side of the examined glass will therefore be higher than the comparative reflection value on the firing side.

### BRIEF DESCRIPTION OF THE DRAWINGS

The following illustrations 1 to 3 show the results measured by the two aforesaid embodiments for the execution of the process according to the invention.

FIG. 1 shows the optical density measured with two different conventional spectrophotometers, whereby in one instance the tin side was oriented towards the source of radiation and in the other the firing side;

FIG. 2 transmission and reflection as a function of wavelength, whereby in the reflection measurement, it was once the tin side and once the firing side oriented toward the source of radiation;

FIG. 3 transmission and reflection as a function of wavelength in a float glass with 1.8 mass percent iron oxide content whereby for the reflection measurement it was once the tin side and once the firing side oriented to the source of radiation.

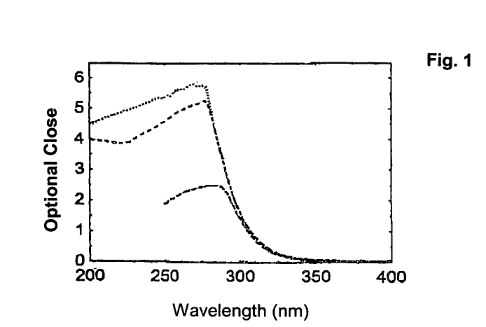

FIG. 1 represents the result of the optic density measurement of a float glass with a thickness of 1.2 mm, using two spectrophotometers disclosing a differential false radiation component. In connection with this illustration, it is manifest that for the execution of the invented process, the selected spectrophotomers should feature a sufficiently small false radiation component in order to permit optimal differentiation between the tin side and the firing side.

One drawback of spectrophotomers consists in the fact that the selected radiation is not strictly monochromatic, but contains always a more or less extensive wavelength-dependent false radiation component whose wavelength does not match the chosen one and is mostly longer. Accordingly, false radiation limits the measuring range to the values of high optical density, inasmuch as with increasing optical density the relative portion of false radiation, which for the sake of simplicity is assumed to be the unabsorbed portion of the tested specimen, increases in relation to the transmitted radiation output.

Optic density OD is defined as OD=log φ/φ₀ whereby φ₀ is the radiation energy impacting the glass specimen and φ represents the radiation energy transmitted through the specimen. An optical density value equal to approx. 6 is the upper limit of the measuring range for modern top-of-the-line equipment.

FIG. 1 illustrates the use of the invented process with two different spectrophotometers on a float glass measuring 1.2 mm in thickness. Manifestly, the lower measuring curve down to an optical density of 2.5, produced by a spectrophotometer with a high false radiation component, permits no differentiation of the two glass surfaces.

Conversely, the two upper curves show that with a spectrophotometer of sufficiently low false radiation component at wavelengths below 275 nanometers, matching here approximately the absorption limit of the tested glass, the measured optical densities are distinctly differentiated, depending on which side the spectrophotometric measurement of the optic density took place.

Thus, the dashed curve shows—with the radiation source of the spectrophotometer facing the tin side of the tested glass, and because of the generated fluorescent radiation capable of penetrating the specimen without absorption—a distinctly lower optical density as compared to a measurement in which the firing side was facing the radiation source and which generated little if any intensity of the fluorescent light Now, if the measured optical densities are used as measured values or reference values in conformity with the invented process, a comparison of these values yields an unequivocal identification of the tin and the firing side.

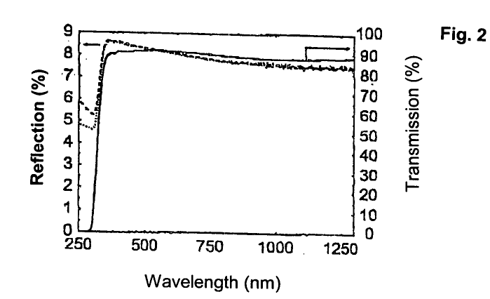

Conversely, FIG. 2 illustrates the use of the alternative process on the same float glass specimen of 1.2 mm thickness. The FIG. 2 shows on the left ordinate the reflection in nearly perpendicular light impact, and on the right ordinate the transmission as a function of the wavelength. As indicated, in the wavelength area with a transmission below 1%, the tin side shows distinctly higher reflection than the firing side. Reflection measured on the tin side is represented by a broken line, while the dotted line represents measurements on the firing side. It is further shown in FIG. 2 that in the virtually absorption-free spectral range in which high transmission is present, there is no significant difference recognizable in the measurements of reflection.

Therefore, once again the reflection measurements according to the invented process should be preferably conducted in a wavelength range where the transmission lies below 10%, preferably below 5% and most preferably below 1%. This low-transmission limit range can be attained in particular with irradiated UV light lying shortwave of the absorption limit of the tested glass, whereby it will be seen that differences in the degree of reflection on the order of 1% can be detected by the measuring technique. By comparing the measured values derived from the reflection pattern of the radiated light, it is again possible to distinguish unequivocally the tin side from the firing side.

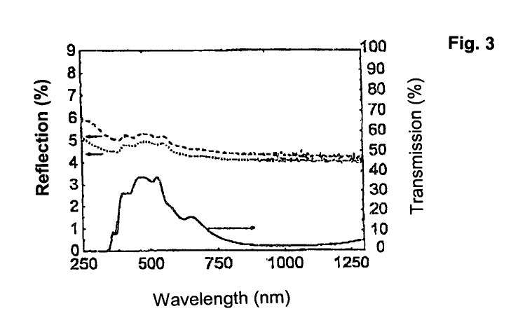

FIG. 3 shows substantially the same measurements on a float glass 4 mm in thickness, with a 1.8 mass % iron oxide content.

Again, reflection and transmission are represented as a function of wavelength, whereby it will be noted that throughout the wavelength range transmission stayed below approximately 3.5%.

Accordingly, because of low transmission, it is possible to differentiate the tin and the firing side throughout the wavelength range since, as clearly visible here, there is a significant difference in reflection throughout this range, being particularly marked in the shortwave range of wavelengths, yielding differences in the degree of reflection on the order of 1%.

Therefore, in the float glass colored green by the iron oxide content, the transmission throughout the measured spectral range is so low that the outcome of the measurements is dominated by the radiation reflected on the frontal glass surface, whereby throughout the wavelength range the reflection is higher on the tin side, represented by the dashed curve, than on the firing side, shown as the dotted curve. Notably, in the area of the highest transmission about the wavelength range of 500 nanometers, the structure of the transmission curve is repeated in the measurements of reflection.

Independent of the possibility to identify on colored glass the tin and the firing sides by the measurement of reflection at any desired wavelength, the preferred wavelength measurements according to the invention lie in the range below 300 nanometers. For example, in an apparatus for the execution of the invented process it is possible to mount a UV fluorescent lamp with an emission maximum at approx. 253 nanometers, using as the receiver or detector of the reflected light a silica photodiode with a sensitive spectral range of about 230 to 350 nanometers.

As pointed out at the outset, the above described process according to the invention as well as the apparatus to be employed therein is not limited to the concretely described measuring procedures with the spectrophotometer or in the reflection arrangement, in that the invented process basically permits assessing by measuring techniques each property, in particular each optical property capable of differentiating the tin side and the firing side, and arriving at a conclusion as to the tin side or the firing side by comparing the measured values secured at or on the two sides.

Inasmuch as the collection of measurement values may be performed automatically by suitable measuring devices, the invented process as well as the apparatus lend themselves optimally for use in the manufacturing, production and further processing as well as fabrication of float glass.

1. A process for the identification of the tin side and the firing side of float glass, particularly during an automated production process, characterized in that a property of the float glass, in particular an optical property, differentiating the tin side and the firing side is assessed by measuring techniques from the direction of one of the two sides or on one of the two sides, and that the resultant measured value is compared with a predetermined reference value, whereby the tin side and the firing side of float glass are determined from the results of the comparison.

2. A process according to claim 1, characterized in that the reference value is determined from the measuring technique assessment of the same, in particular optical, property from the direction or on the other side of the float glass.

3. A process according to claim 1 wherein the measured value and/or the reference value of the property depends on the intensity of the fluorescent light generated on a float glass surface by an irradiated UV light.

4. Process according to claim 3, wherein that the measured value and/or the reference value depends on the intensity, measured in transmission, of the fluorescent light generated upon one side of the float glass.

5. Process according to claim 4, wherein the optical density of the float glass constitutes the measured value and/or the reference value.

6. A process according to claim 1, wherein the measured value and/or the reference value of the property depends on the intensity of a reflected light generated by an irradiated light, whereby the light in only reflected on the first surface of the float glass in the direction of irradiation.

7. An apparatus for the identification of tin and firing sides of float glass, in particular during an automated production process, characterized in that it comprises a measuring device, by means of which it is possible to assess a property of the float glass, in particular an optical property, differentiating the tin side and the firing side, from the direction or upon one of the two sides, and a measured value resulting from a measurement is compared with a predetermined reference value, whereby the tin side and the firing side may be determined from the result of the comparison.

8. An apparatus according to claim 7, characterized in that it features a measuring device by means of which the reference value may be established from the measuring technique assessment of the same, particularly optical, property from the direction or on the other side of the float glass.

9. An apparatus according to claim 7, characterized in that by means of a measuring device it is possible to determine the measured value/reference value dependent on the intensity of a fluorescent light generated by the incidence of light from one of the sides, especially after transmission of the fluorescent light through the float glass.

10. An apparatus according to claim 7, characterized in that it comprises a spectrophotometer for the measurement of the optical density of float glass, particularly as a function of the direction of the transirradiation.

11. An apparatus according to claim 7, characterized in that by means of a measuring device it is possible to determine a measured value and/or the reference value dependent upon the intensity of light reflected from a float glass surface.

12. An apparatus according to claim 7, characterized in that it comprises a source of light, in particular a source of UV light, and a detector for the measurement of light intensity, in particular a photodiode.

13. An apparatus according to claim 12, characterized in that the source of light is formed by a UV fluorescent lamp, in particular with an emission peak at 253 nm.

14. An apparatus according to claim 12, characterized in that the detector for the measurement of the light intensity features a sensitive spectral range from 230 nm to 350 nm.

15. Use of a spectrophotometer for identification of tin and firing sides of float glass in accordance with the process according to claim 1.
